(19) United States
(12) Patent Application Publication
(10) Pub. No.: US 2026/0018839 A1
(43) Pub. Date: Jan. 15, 2026

(54) RESET BUTTON WITH LIGHT PIPE FOR INDICATING STATUS OF ELECTRICAL WIRING DEVICE

(71) Applicant: EATON INTELLIGENT POWER LIMITED, DUBLIN (IE)

(72) Inventors: Chuanchuan Zhuang, Shanghai (CN); Erik J. Gouhl, Fayetteville, GA (US); Christopher G. Henley, Pittsburgh, PA (US)

(73) Assignee: EATON INTELLIGENT POWER LIMITED, DUBLIN (IE)

(21) Appl. No.: 19/262,352

(22) Filed: Jul. 8, 2025

Related U.S. Application Data
(60) Provisional application No. 63/669,034, filed on Jul. 9, 2024.

(51) Int. Cl. H01R 13/717; H01R 13/713

(52) U.S. Cl. CPC H01R 13/7172; H01R 13/7135

(57) ABSTRACT

An improved ground fault circuit interrupter (GFCI) receptacle includes a reset button coupled to a light pipe. The reset button and light pipe are designed to be coupled to one another in a manner ensuring that they cannot be unintentionally uncoupled and which uses minimal space in the GFCI housing. The light pipe has a main body and a lever protruding from the main body. The main body has a surface visible from the front of the GFCI, and the lever protrudes orthogonally from the main body. A sidewall of the reset button comprises an opening structured to receive the light pipe lever only when the lever is positioned in a specific orientation. When the lever is received in the opening of the reset button, the light pipe can be rotated until a notch formed in the lever snap fits onto the sidewall of the reset button.

### CROSS REFERENCE TO RELATED APPLICATIONS

This application claims priority to U.S. Provisional Patent Application Ser. No. 63/669,034, filed on Jul. 9, 2024 and titled “RESET BUTTON WITH LIGHT PIPE FOR INDICATING STATUS OF ELECTRICAL WIRING DEVICE”, the disclosure of which is incorporated herein by reference.

### FIELD OF THE INVENTION

The disclosed concept relates generally to electrical wiring devices, and in particular, to mechanisms that indicate the status of a ground fault circuit interrupter (GFCI) device.

### BACKGROUND OF THE INVENTION

Electrical wiring devices are devices that are installed in a structure to enable users to safely access utility or mains power by, for example and without limitation, providing a plug point (i.e. electrical outlet) for plug-in electrical devices. Ground fault circuit interrupters (GFCIs) are a specific type of electrical wiring device configured to detect ground faults, and are typically required to be installed in those areas of a structure in close proximity to water, such as kitchens and bathrooms. A GFCI includes openings structured to receive plug prongs that enable load devices to be plugged into the GFCI. The GFCI includes mechanically separable contacts that can be actuated between a closed state and an open state. When the separable contacts are closed, a load device plugged into the GFCI is able to receive electrical power. When the separable contacts are open, the load device is unable to receive electrical power through the GFCI.

The GFCI includes a reset button that is mechanically linked to the mechanism that causes opening and closing of the separable contacts, and the position of the reset button thus indicates whether or not the separable contacts are open or closed. The reset button is structured to be moved between a depressed position and an extended position. Typically, when the separable contacts are closed, the reset button is in the depressed position. When the separable contacts are closed and GFCI device detects a ground fault, the GFCI automatically trips open the separable contacts, and the tripping open of the separable contacts causes the reset button to extend to its extended position. The separable contacts can only be reclosed if a user manually depresses the reset button from the extended position back to the depressed position. GFCIs also include a test button, typically positioned next to the reset button. Pressing the test button when the separable contacts are closed (i.e. when the reset button is in the depressed position) simulates a ground fault condition, and if the GFCI is in good working condition, pressing the test button should cause the reset button to move to its extended position and open the separable contacts.

Given how widespread the use of GFCIs is, it is always desirable to make the state of the separable contacts, i.e. either open or closed, as easy to discern as possible.

The present invention thus provides a solution that makes the state of the separable contacts of a GFCI highly visible.

### SUMMARY OF THE INVENTION

These needs, and others, are met by an improved ground fault circuit interrupter (GFCI) receptacle that includes a reset arrangement comprising a reset button coupled to a light pipe, with the light pipe being positioned in close proximity to an LED. In addition to the extended or depressed position of the reset button, the color/state of the LED can be used to easily convey the reset status of the GFCI circuit. The reset button and light pipe are designed to be coupled to one another in a manner ensuring that they cannot be unintentionally uncoupled and which uses minimal space in the GFCI housing.

In accordance with one aspect of the disclosed concept, a GFCI receptacle includes a reset arrangement that comprises: a reset button, a light pipe, and a light source. The reset button has a front surface accessible from the exterior of the GFCI receptacle. The light pipe comprises a main body, with a majority of the surface area of the main body extending in a pipe height dimension and a pipe width dimension. The main body comprises a first end and a second end disposed opposite one another relative to the pipe height dimension. The reset button extends in a receptacle height dimension, a receptacle width dimension, and a receptacle depth dimension, with the receptacle height dimension, receptacle width dimension, and receptacle depth dimension all being orthogonal to one another and fixed relative to the reset button. The front surface of the reset button extends in the receptacle width and receptacle depth dimensions. A longitudinal axis of the main body extends in a pipe depth dimension. The pipe height dimension, pipe width dimension, and pipe depth dimension are all orthogonal to one another and fixed relative to the light pipe. The light pipe is coupled to the reset button such that the longitudinal axis of the main body extends in the receptacle height dimension and the first end of the light pipe is disposed adjacent to the front surface of the reset button in the receptacle depth dimension. The second end of the light pipe is disposed so as to face the light source such that light emitted from the light source is directed from the second end of the light pipe to the first end.

### BRIEF DESCRIPTION OF THE DRAWINGS

A full understanding of the invention can be gained from the following description of the preferred embodiments when read in conjunction with the accompanying drawings in which:

FIG. 1 is an isometric view of an improved GFCI receptacle with a light pipe status indicator, in accordance with an exemplary embodiment of the disclosed concept;

FIG. 2 is a side elevation view of the improved reset arrangement included in the GFCI receptacle of FIG. 1;

FIG. 3 is an isometric view of the reset arrangement of FIG. 2 coupled to a middle housing of the GFCI receptacle of FIG. 1; and

FIGS. 4A-4C show the stages of how a light pipe gets coupled to a reset button in order to form the reset arrangement of FIG. 2.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As employed herein, employed herein, when ordinal terms such as “first” and “second” are used to modify a noun, such use is simply intended to distinguish one item from another, and is not intended to require a sequential order unless specifically stated.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, the term “number” shall mean one or an integer greater than one (i.e., a plurality).

As described above, a working GFCI receptacle typically has two primary states: a state in which the separable contacts are closed (and the reset button is depressed), and a state in which the separable contacts are open (and the reset button is extended). It is always desirable to make the state of a GFCI receptacle as easy to ascertain as possible. The disclosed improved GFCI receptacle 1 includes a light pipe that is visible on the front surface of the GFCI receptacle 1 in order to make the state of the GFCI readily apparent. A light pipe is a transparent or semi-transparent tube or tube-like structure positioned with one end of the tube in close proximity to a light source. Positioning the tube near the light source causes some or all of the tube to illuminate.

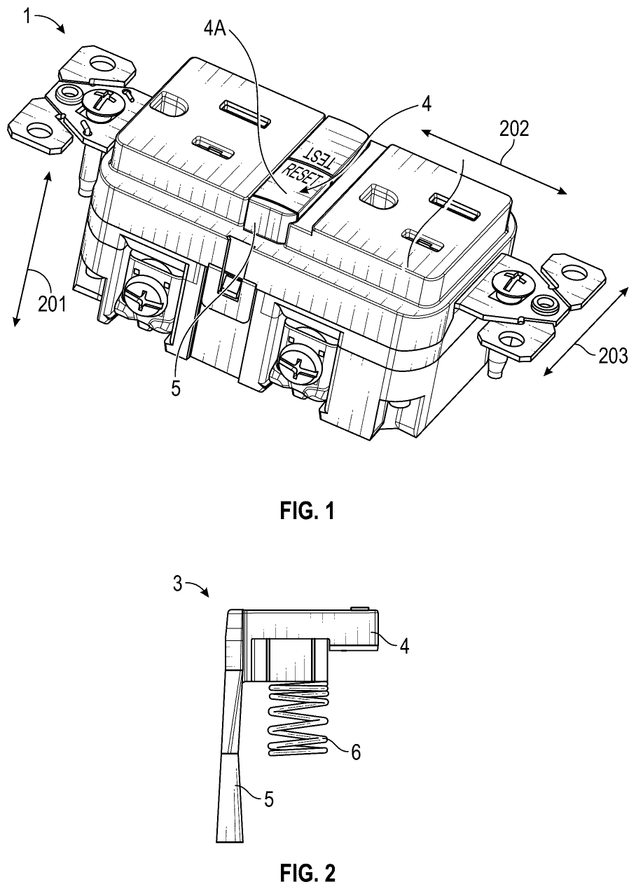

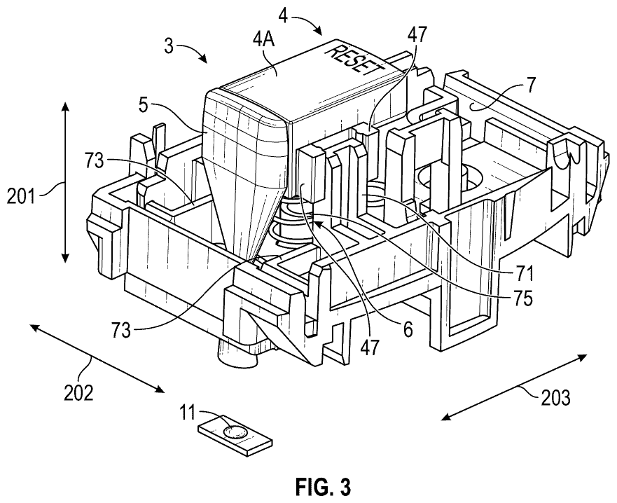

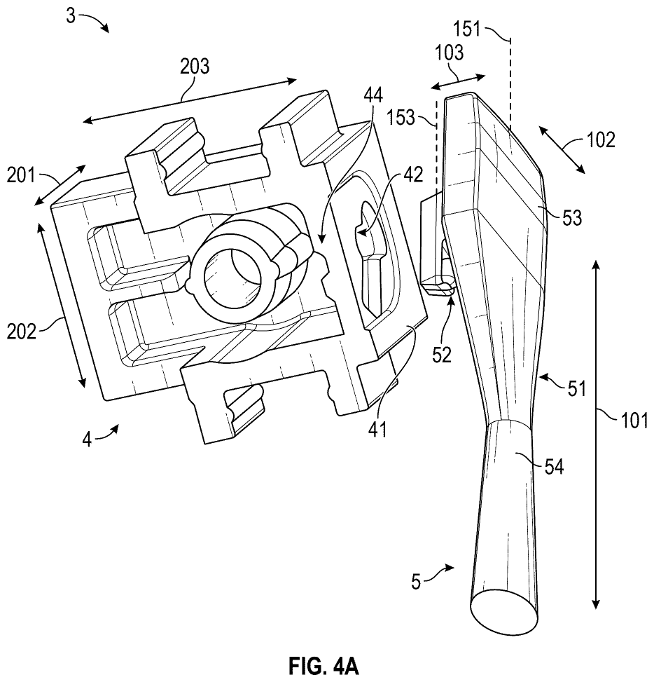

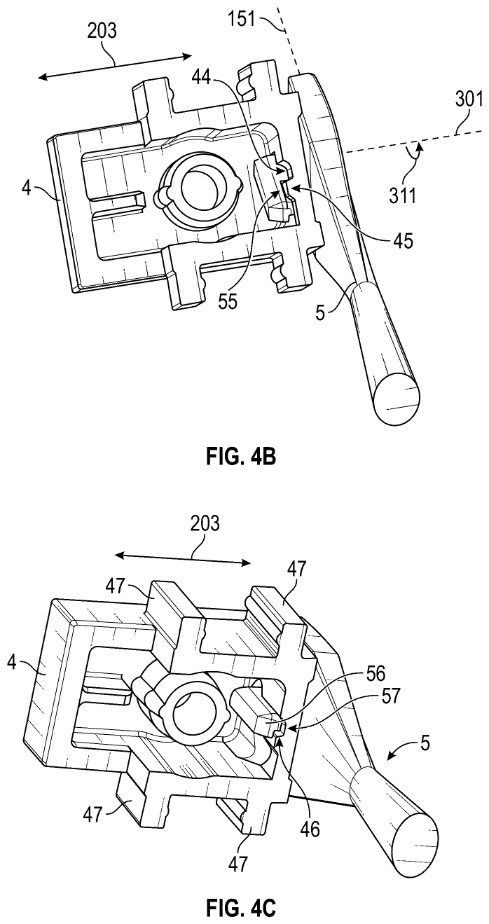

FIG. 1 shows an improved GFCI receptacle 1 that includes a status indicator light pipe, in accordance with an exemplary embodiment of the disclosed concept. Referring to FIG. 2 in conjunction with FIG. 1, the improved GFCI receptacle 1 includes an improved reset arrangement 3 that comprises a reset button 4 and an indicator light pipe 5 (which are visible from the exterior of the GFCI receptacle, as shown in FIG. 1) that are structured to be coupled to one another in an advantageous manner, as detailed further later herein in conjunction with FIGS. 4A-4C. The GFCI receptacle 1 further comprises a spring 6 (referred to hereinafter as the “reset spring 6”) that actuates the reset button 4 to move from a depressed state to an extended state. The depressed state corresponds to separable contacts (not visible in the figures) of the GFCI receptacle 1 being closed, and the extended state corresponds to the separable contacts being open. In FIG. 2, the reset button 4 and light pipe 5 are shown fixedly coupled to one another before being coupled to the housing structures of the GFCI receptacle 1. FIG. 3 shows the reset button 4 and light pipe 5 after they have been inserted into a middle housing 7 of the GFCI receptacle 1. As numbered in FIG. 1, the GFCI receptacle 1 includes a top housing 8 and a bottom housing 9. When the GFCI receptacle 1 is fully assembled, the top housing 8 and bottom housing 9 enclose the middle housing 7.

As shown in FIG. 3, the GFCI receptacle 1 is structured so that a front end of the light pipe 5 is adjacent to a front surface 4a of the reset button 4 and visible from the front surface of the GFCI receptacle 1, and is further structured such that a second end of the light pipe 5 disposed opposite the front end is in proximity to a light source, e.g. an LED 11. It will be appreciated that the ground fault detection circuit of a GFCI device is typically included on a printed circuit board (PCB) or similar structure, and it is noted that the LED 11 shown in FIG. 3 can be coupled to a PCB. In both FIG. 3 and FIG. 1, the reset arrangement 3 is shown in the extended state, due to the reset spring 6 not being compressed. When a user manually depresses the reset button 4 to the depressed state, the light pipe 5 will be in closer proximity to the LED 11 (FIG. 3). The light of the LED 11 is visible on the top surface of the GFCI receptacle 1 through the light pipe 5.

It will be appreciated that the LED 11 and light pipe 5 can be used to denote the state of the GFCI receptacle 1 in a variety of ways. For example and without limitation, the LED 11 can be configured to emit light when the reset button 4 is in the depressed position and configured to stop emitting light when the reset button 4 is in the extended position. In another non-limiting example, the LED 11 can be configured to emit light of a first color (e.g. green) when the reset button 4 is in the depressed position and configured to emit light in a second color (e.g. red) when the reset button 4 is in the extended position.

Reference is now made to FIGS. 4A-4C, which show how the reset button 4 and light pipe 5 are advantageously structured to be coupled to one another in a manner that is easy to implement during an automated manufacturing process for the GFCI receptacle 1 and ensures that the light pipe 5 and the reset button 4 do not become separated inadvertently. As an initial matter, it is noted that there are three dimensions numbered in FIGS. 4A-4C that are fixed relative to the light pipe 5: a pipe height dimension 101, a pipe width dimension 102, and a pipe depth dimension 103, with all three pipe dimensions 101, 102, 103 being orthogonal to one another. These dimensions are used to provide a common frame of reference between the figures for the orientation of the light pipe 5. It should be noted that these three dimensions are fixed relative to the light pipe 5 such that, as the light pipe 5 moves, the pipe dimensions 101, 102, 103 also move.

In addition, there are three receptacle dimensions numbered in the figures that are fixed relative to the housing structures of the GFCI 1 (the housing structures being the top housing 8, the bottom housing 9, and the middle housing 7): a receptacle height dimension 201, a receptacle width dimension 202, and a receptacle depth dimension 203, with all three receptacle dimensions 201, 202, 203 being orthogonal to one another. These receptacle dimensions are used to provide a common frame of reference between the figures for the orientation of the overall GFCI receptacle 1 and the orientation of the reset button 4 within the GFCI receptacle 1. It should be noted that these three dimensions are fixed relative to the GFCI receptacle 1 such that, as the GFCI receptacle 1 moves, the receptacle dimensions 201, 202, 203 also move.

As numbered in FIG. 4A, the light pipe 5 comprises a main body 51 and a lever 52 that extends from the main body 51 in the pipe depth dimension 103. The main body 51 comprises a base 53 and a handle 54 that extends from the base 53 in the pipe height dimension 101. It is noted that the light pipe 5 is a unitary body, such that the main body 51 and the lever 52 are specific portions of the unitary body that have fixed orientations relative to one another, and the base 53 and handle 54 are specific portions of the main body 51 that have fixed orientations relative to one another. The main body 51 is longest in the pipe height dimension 101. A longitudinal axis 151 of the main body 51 is numbered in FIG. 4A. The longitudinal axis 151 extends in the pipe height dimension 101 and is positioned midway along the length of the base 53 in the pipe width dimension 102. It is noted that, in the pipe depth dimension 103, the lever 52 extends from specifically from the base 53 of the main body 51. The lever 52 is longest in the pipe height dimension 101, such that a longitudinal axis 153 of the lever 152 lies in the pipe height dimension 101 and is parallel to the longitudinal axis 151.

A sidewall 41 of the reset button 4 is formed with a lever receiving opening 42 structured to receive the lever 52 of the light pipe 5. The majority of the surface area of the sidewall 41 extends in the receptacle height 201 and receptacle width 202 dimensions. The lever receiving opening 42 and the lever 52 are both shaped such that the lever 52 must be positioned in a specific orientation in order for the lever 52 to fit within the lever receiving opening 42. Specifically, the lever 52 must be positioned such that its longitudinal axis 153 is positioned at a 45 degree angle relative to the receptacle width dimension 202. FIG. 4B shows the lever 52 inserted into the lever receiving opening 42.

The thickness of sidewall 41 extends in the receptacle depth dimension 203. A button notch 44 is formed in the thickness of the sidewall 41 and a button protrusion 45 is formed in the thickness of the sidewall adjacent to the button notch 44. As numbered in FIG. 4B, the lever 52 is formed with a lever notch 55. The lever notch 55 is positioned such that, once the lever 52 of the light pipe 5 is inserted into the lever receiving opening 42 of the reset button 4 and received within the interior of the reset button 4 as shown in FIG. 4B, the lever notch 55 receives the button protrusion 45. With the button protrusion 45 received in the lever notch 55, the light pipe 5 can be rotated around an axis of rotation 301 in a rotation direction 311 (depicted in FIG. 4B). While rotating in the rotation direction 311, the lever notch 55 maintains engagement with the button protrusion 45. The axis of rotation 301 extends in the receptacle depth dimension 203, and is thus orthogonal to the receptacle height and width dimensions 201, 202. It will be appreciated that the handle 54 of the lever 5 is used to rotate the lever 5. Rotating the light pipe lever 52 in the rotation direction 311 so that the light pipe lever 52 and the lever receiving opening 42 in the reset button 4 are no longer aligned prevents the light pipe 5 from being separated from the reset button 4, as the sidewall 41 will obstruct movement of the light pipe 5 if the light pipe 5 is pulled in the receptacle depth dimension 203.

The lever 52 is structured such that the light pipe 5 can continue to be rotated in the rotation direction 311 until the lever 52 is seated within the button notch 44, as shown in FIG. 4C. As numbered in FIG. 4C, the reset button 4 comprises a button corner 46 located between the button notch 44 and the button protrusion 45, and the lever 52 is formed with a corner notch 56. The corner notch 56 is structured to snap fit onto the button corner 46 once the lever 52 is received within the button notch 44. Once the corner notch 56 snap fits onto the button corner 46, the lever 52 cannot be rotated out of engagement with the button notch 44 (i.e. cannot be rotated in a direction opposite the rotation direction 311), because a side edge 57 of the lever 52 is positioned further in the receptacle depth dimension 203 than the button protrusion 45 is, such that the side edge 57 cannot clear the button protrusion 45 if the lever 52 were to attempt to rotate in a direction opposite the rotation direction 311. The light pipe 5 thus becomes securely coupled to the reset button 4 once the lever 52 is received within the button notch 44. It is noted that the light pipe 5 is considered fully coupled to the reset button 4 once the light pipe 5 is oriented such that the longitudinal axis 151 of the main body 51 extends in the receptacle height dimension 201. It will be appreciated that uncoupling the light pipe 5 from the reset button 4 requires a non-trivial amount of manual force being intentionally applied to move the corner notch 56 of the light pipe 5 out of engagement from the button corner 46. Other embodiments of the reset arrangement 3 can include securing the light pipe 5 to the reset button 4 by ultrasonic welding, over molding, adhesives, etc.

Referring once more to FIG. 3, it can be seen that the middle housing 7 is formed with a male guide rail 71 and that the reset button 4 is formed with female guide rails 47 (also numbered in FIG. 4C). When the reset arrangement 3 is coupled to the middle housing 7, the male guide rail 71 of the middle housing 7 is received within the female guide rails 47 of the reset button 4. The guide rails 47 and 71 ensure that the reset button 4 and the light pipe 5 only move in the receptacle height dimension 201 when the reset arrangement 3 is coupled to the middle housing 7. It is noted that the reset arrangement 3 is shown in the extended position in FIG. 3 (corresponding to the separable contacts being open), and that the structure of the top housing 8 obstructs movement of the female guide rails 47 beyond a certain point in the receptacle height dimension 201 when the reset arrangement 3 moves from the depressed position to the extended position. In addition, the middle housing 7 includes blocking structures 73 that obstruct movement of the female guide rails 47 beyond a certain point in the receptacle height dimension 201 when the reset arrangement 3 moves from the extended position to the depressed position (i.e. when the GFCI circuit is reset to reclose the separable contacts). The middle housing 7 further includes a spring mount 75 which seats the reset spring 6.

From the foregoing description of the disclosed improved GFCI receptacle 1, it should be noted that the design of the reset button 4 and the design of the light pipe 5 are advantageous in that they enable simple and fast coupling of the light pipe 5 to the reset button 4 during an automated assembly process, and they prevent the light pipe 5 from becoming separated from the reset button 4 without the application of intentional force. That is, once the light pipe 5 is coupled to the reset button 4 such that the lever 52 of the light pipe 5 is snap fit into the button notch 44, intentional force must be applied to snap the lever out 52 of engagement with the button notch 44. This particular coupling method also enables the light pipe 5 and the reset button 4 to be firmly connected to one another in the narrow space of the middle housing 7 and overall structure of the GFCI receptacle 1. This coupling enables the reset arrangement 3 to remain stable and reliable within the housing structures of the GFCI receptacle 1 even if the GFCI receptacle 1 is subjected to high-frequency motion.

It is noted that the portion of the light pipe 5 visible from the exterior of the GFCI receptacle 1 does not occupy a significant amount of space in either the receptacle width dimension 202 or a receptacle depth dimension 203. In particular, said portion of the light pipe 5 is no longer than the reset button 4 in the width dimension 202, as can be seen in FIG. 1 and FIG. 3. In addition, the guide rails 71 and 47 formed on the middle housing 7 and on the reset button 4 advantageously enable the reset arrangement 3 to easily be inserted into the middle housing 7 during the automated assembly process. Furthermore, the guide rails 71 and 47 on the middle housing 7 and the reset button 4 ensure that the reset arrangement 3 moves only in the receptacle height dimension 201 without being offset by any forces applied to the reset arrangement 3 in either of the receptacle width or depth dimensions 202, 203.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A GFCI receptacle, the GFCI receptacle comprising:
a reset arrangement, the reset arrangement comprising:
a reset button, the reset button having a front surface accessible from the exterior of the GFCI receptacle; and
a light pipe, the light pipe comprising:
a main body, a majority of the surface area of the main body extending in a pipe height dimension and a pipe width dimension, the main body comprising a first end and a second end disposed opposite one another relative to the pipe height dimension; and
a light source,
wherein the reset button extends in a receptacle height dimension, a receptacle width dimension, and a receptacle depth dimension, with the receptacle height dimension, receptacle width dimension, and receptacle depth dimension all being orthogonal to one another and fixed relative to the reset button,
wherein the front surface of the reset button extends in the receptacle width and receptacle depth dimensions,
wherein a longitudinal axis of the main body extends in a pipe depth dimension,
wherein the pipe height dimension, pipe width dimension, and pipe depth dimension are all orthogonal to one another and fixed relative to the light pipe,
wherein the light pipe is coupled to the reset button such that the longitudinal axis of the main body extends in the receptacle height dimension and the first end of the light pipe is disposed adjacent to the front surface of the reset button in the receptacle depth dimension, and
wherein the second end of the light pipe is disposed so as to face the light source such that light emitted from the light source is directed from the second end of the light pipe to the first end.

2. The GFCI receptacle of claim 1, further comprising:
a middle housing, the middle housing comprising a male guide rail,
wherein the reset button comprises female guide rails,
wherein the female guide rails receive the male guide rail in order to couple the reset arrangement to the middle housing.

3. The GFCI receptacle of claim 1,
wherein the reset button further comprises:
a sidewall; and
a lever receiving opening formed in the sidewall,
wherein the light pipe further comprises a lever, the lever protruding from the main body in the pipe depth dimension,
wherein the lever is structured such that the lever has only one orientation relative to the sidewall that is an insertion orientation, and the lever receiving opening is structured to only receive the lever when the lever is positioned in the insertion orientation, and
wherein the sidewall and the light pipe are structured such that:
after the lever is received within the interior of the reset button through the lever receiving opening, the lever can be rotated in a direction of rotation about an axis that extends in the receptacle depth dimension, and
once the lever is received within the interior of the reset button, rotating the lever in the direction of rotation and out of alignment from the lever receiving opening prevents the lever from being removed from the interior of the reset button.

4. The GFCI receptacle of claim 3,
wherein the insertion orientation is an orientation in which the longitudinal axis of the lever is disposed at a 45 degree angle relative to receptacle width dimension.

5. The GFCI receptacle of claim 3,
wherein the sidewall of the reset button comprises a button notch and a button protrusion formed adjacent to the button notch, and
wherein the lever snap fits onto the sidewall when the lever has rotated sufficiently far in the direction of rotation such that the lever is received in the button notch.

6. The GFCI receptacle of claim 5,
wherein the lever is formed with a lever notch,
wherein the lever notch is positioned such that, after the lever is received within the interior of the reset button, the lever notch receives the button protrusion, and
wherein the lever notch is structured to maintain engagement with the button protrusion as the lever rotates in the direction of rotation.

7. The GFCI receptacle of claim 5,
wherein the light pipe and reset button are structured such that the first end of the light pipe is disposed adjacent to the front surface of the reset button in the receptacle depth dimension only once the lever has snap fit onto the sidewall.

8. The GFCI receptacle of claim 2,
wherein the middle housing and the reset arrangement are positioned such that pushing the front surface of the reset button in the receptacle height dimension pushes the second end of the light pipe closer to the light source.

9. The GFCI receptacle of claim 8, further comprising:
a front housing coupled to the middle housing,
wherein the front housing is structured such that the front housing covers a front side of the middle housing while leaving the front surface of the reset button and the first end of the light pipe exposed.

10. The GFCI receptacle of claim 2, further comprising:
a spring,
wherein the middle housing comprises a spring mount,
wherein the spring is mounted on the spring mount and positioned between the middle housing and the reset button, and
wherein the reset arrangement is structured such that pushing the front surface of the reset button compresses the spring.
